(19) United States
(12) Patent Application Publication
(10) Pub. No.: US 2006/0085538 A1
(43) Pub. Date: Apr. 20, 2006

(54) System and method for enhanced network monitoring

(75) Inventors: Scott Newman, Little Elm, TX (US); Eric Bearden, Forney, TX (US); Jason E. Savard, McKinney, TX (US); Jonathan Paden, Austin, TX (US); Bobby Sams, Austin, TX (US); Charles Brent Kendall, San Antonio, TX (US)

Correspondence Address: AKERMAN SENTERFITT, P.O. BOX 3188, WEST PALM BEACH, FL, 33402-3188, US

(73) Assignee: SBC Knowledge Ventures, L.P., Reno, NV (US)

(21) Appl. No.: 10/965,420

(22) Filed: Oct. 14, 2004

(51) Int. Cl. G06F 15/173

(52) U.S. Cl. 709/224

(57) ABSTRACT

A system for monitoring a communication network for actual and potential network problems is provided. The system includes a communication tracking module to track network communications between at least one network-user device and a network service provider device during a predefined time interval. The network communications are based upon a user-supplied indication of a network problem. The system also includes a report generating module to generate a report based upon the network communications tracked, and a threshold determination module to determine whether the number of network communications exceeds a predetermined threshold.

### BACKGROUND

1. Field of the Invention

The present invention is related to the field of communication networks, and, more particularly, to the field of data communication networks

2. Description of the Related Art

Internet users typically access the Internet through an Internet Service Provider (ISP), which provides a user a connection to the Internet by establishing a communication link between the user's computer and a computing device operated by the ISP. An ISP has access to the Internet and can provide remote dial server access ports for users to use in establishing connections via modem dial-up. Thus, ISP-provided access to the Internet is usually established by the user's dialing one or more local-access telephone numbers and thereby establishing a communication link occurs across a phone line. Access services provided by an ISP can include Web hosting, email, VoIP (voice over IP), and support for many other applications.

An Internet dial-up user who experiences problems connecting to, or using, the Internet via a local-access number can report the problem to the user's ISP in alternative ways. To efficiently handle user reports of network problems, many ISPs utilize an interactive voice response (IVR) system. An IVR system is an automated call handling system by which the user interacts with a computer-controller voice signal comprising either recorded real speech or computer-generated synthesized speech. The user's interaction with the IVR system of an ISP can be through the use of a touch tone telephone or through speech recognition. Another automated reporting mechanism that ISPs use involves dial-up users leaving voice mail messages reporting details of a network problem encountered by a user.

An ISP should promptly respond to problems reported by users. Before a response is possible, however, the ISP agent typically needs to ascertain the nature of the problem and then assesses how best to correct the problem. A response to a user's problem, for example, can entail connecting the user to an IVR help menu or to a technical support agent, each chosen specifically for the ascertained problem.

Although ISPs are able to collect and analyze different types of network data for various purposes, there remains a need for an efficient way of identifying and predicting specific network problems based upon calls into and/or out of an IVR. More particularly, it would be desirable to use calling data stemming from a user's reporting of a network problem to ascertain if the problem were unique to a particular user or reflected an on-going or worsening network problem. Moreover, it would be desirable in the case of a network problem, to use calling data resulting from a user's reporting of a network problem to locate the locus of the network problem.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a communications network including a system according to one embodiment of the present invention.

FIG. 2 is a schematic diagram of the system in FIG. 1.

FIG. 3 is a schematic diagram of graphical user interface that can be generated by the system in FIG. 1.

FIG. 4 is a schematic diagram of another graphical user interface that can be generated by the system in FIG. 1.

FIG. 5 is a schematic diagram of yet another graphical user interface that can be generated by the system in FIG. 1.

FIG. 6 is a flowchart of a method according to another embodiment of the present invention.

### DETAILED DESCRIPTION OF THE INVENTION

The present invention comprises a system and related methods for identifying and locating actual or potential problems in a communication network, such as the Internet or other data communication network. The system provides an early warning for possible network problems that could otherwise go undetected by a network service provider. Since actual and potential network problems are very likely to be reported to the network service provider by a network user who is experiencing some type of network problem, the system tracks network communications between the network user and the network service provider. Network communications thus include communications originating with a network user reporting a problem as well as communications from a network service provider responding to a report of a problem.

Additionally, the network-user device that is used for reporting a problem can be correlated to a particular network or location via, for example, an automatic number identification (ANI). Therefore, tracking the network communications relating to a network user's reporting an actual and potential problem further serves to allow the network service provider to locate where a particular problem appears to be occurring or developing.

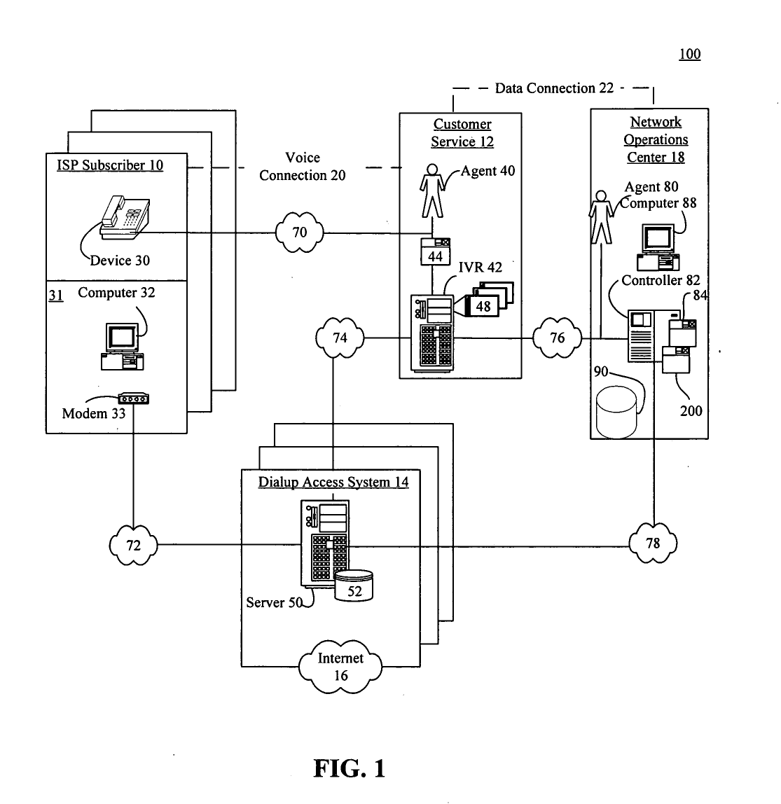

FIG. 1 is a schematic diagram illustrating elements of a data communication network 100 in which a system according to the present invention can advantageously be used for identifying and locating actual and potential network problems. The network 100 illustratively includes an ISP, defining a network service provider, and a plurality of network users 10, illustratively comprising ISP subscribers. As illustrated, the network 100 further includes an ISP-operated customer service center 12, a network reliability center or network operation center (NOC) 18 where the network is monitored by the ISP, and a dialup access system 14.

The dialup access system 14 can grant Internet 16 access to the ISP subscribers or network users 10. A network user 10 communicates via a network-user device 31 that illustratively comprises a computer 32 that attaches to a modem 33. Typically, the network-user device 31 will communicatively link to a server 50 across network 72. The server 50 will provide network connectives using one or more ports, each port being associated with one or more dialup access numbers. Dialup account information contained in data store 52 can be used by the dialup access system 14 to ascertain an access account of an ISP subscriber, or network user 10, and to provide account authorization.

The customer service center 12 can receive calls from an ISP subscriber or network user 10 pertaining to network problems. The customer service center 12 can include a customer service agent 40 and an interactive voice response system (IVR) or similar type device defining a network service provider device 42, that interfaces with the ISP subscriber or network user 10 through an interface 44. The IVR or network service provider device 42 can be directly linked to the server 50 via network 74. Through this link, the IVR or network service provider device 42 can access information contained in the data store 52.

The IVR or network service provider device 42 can be a system that accepts a combination of voice telephone input and/or touch-tone keypad input. Additionally, the IVR or network service provider device 42 can receive input directly from the network-user device 31. The IVR or network service provider device 42 also can provide appropriate feedback in the form of voice, fax, callback, e-mail, and other suitable media. In one embodiment, the IVR or network service provider device 42 can be a part of a larger application that includes database access, such as a customer service database (not shown) that can be included within the customer service center 12. Notably, the IVR or network service provider device 42 can enter a dialogue with the ISP subscriber or network user 10 in real-time. The dialogue can be controlled using a series of pre-established menus 48.

Additionally, the customer service center 12 can be communicatively linked to the NOC 18 via a data connection 22. More specifically, the IVR or network service provider device 42 can be communicatively linked to the controller 82 via network 76. The NOC 18 can be a center that provides technical support for one or more dial-up access numbers. That is, the NOC 18 provides a support infrastructure that permits the dialup access system 14 to function. The NOC 18 can include one or more live agents 80 and a network controller 82.

The network controller 82 can be one or more communicatively linked computer devices and peripherals that collectively maintain, monitor, and analyze hardware, software, and communication links associated with the dialup access system 14. That is, problem reports generated by the IVR or network service provider device 42 can be conveyed to the network controller 82 in real-time. The network controller 82 can responsively initiate a programmatic action in response.

In one embodiment, the NOC 18 can receive problem indications from a multiple sources. These sources can include network monitoring software 84, agents 80, and the user problem reports received via the IVR or network service provider device 42 and/or a customer service agent 40. The monitoring software 84 can monitor the dialup access system 14 across network 78. The NOC 18 can correlate and combine data from each of these sources to determine a likelihood that a problem exists. Different actions can be taken based upon the likelihood score and/or the criticality of reported problems.

As used herein, voice link 20 can be a standard public switched telephone network (PSTN) connection, which is typically a circuit-switched connection. The voice link 20 is not limited in this regard, however, and a packet-based connection that utilizes a technology like Voice over Internet Protocol (VoIP) can also form the voice link 20. The data link 22 can be any communication link capable of digitally conveying information.

Accordingly, networks 70, 72, 74, 76, 78, and 16 can be implemented as any of a variety of fashions so long as content is conveyed using encoded electromagnetic signals. Further, any of a variety of communication devices, such as customer premise equipment (CPE), computers, modems, routers, switches, and similar devices, can be included within networks 70, 72, 74, 76, 78, and 16.

Each of the networks 70, 72, 74, 76, 78, and 16 can convey content in a packet-based or circuit-based manner. Additionally, each of the networks 70, 72, 74, 76, and 78 can convey content via landlines or wireless data communication methods. For example, each of the networks 70, 72, 74, 76, and 78 can separately include an Intranet, a local area network, a wide area network, or a combination thereof. In another example, each of the networks 70, 72, 74, 76, and 78 can include a telephony network, like a mobile wireless network or a public switched telephone network (PSTN). It should be appreciated that the arrangements shown in FIG. 1 are for illustrative purposes only and that the invention is not limited in this regard. The functionality attributable to the various components can be combined or separated in different manners than those illustrated herein. For instance, the network operations center 18 can be integrated with the dialup access system 14 in one embodiment.

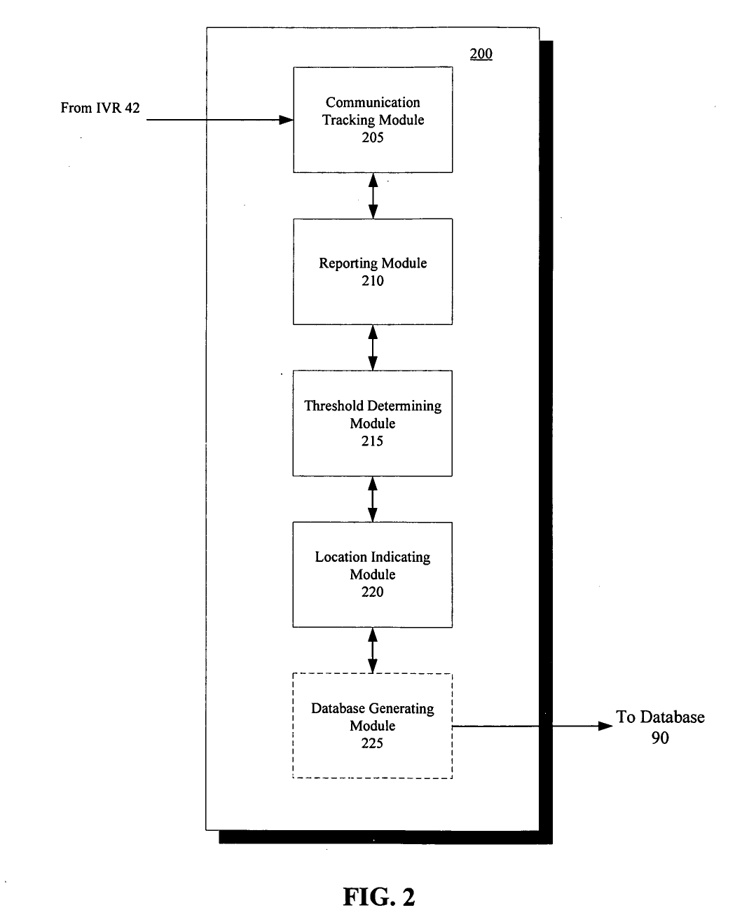

The system 200 for identifying and locating actual and potential problems in the network is illustratively implemented as a set of software components configured to be instantiated by the controller 82 at the NOC 18. The system 200 is communicatively linked to a database 90, the database storing entries generated by the system 200 based upon tracked network communications as explained below. Referring additionally to FIG. 2, the system 200 illustratively includes a communication tracking module 205, a reporting module 210, and a threshold determining module 215 communicatively linked to one another.

The communication tracking module 205 tracks network communications that take place between any of the network-user devices 31 and the IVR or network service provider device 42 during a predefined time interval. As already noted the IVR or network service provider device 42 can accept a voice telephone input and/or touch-tone keypad input as well as direct input from the network-user device 31. Therefore, it follows that a network communication tracked by the communication tracking module 205 can correspond to a communication from a network user via one or more of these modes reporting an actual and potential network problem.

Moreover, as also noted already, the IVR 42 or network service provider device can be configured to also provide feedback to a user in the form of voice, fax, callback, e-mail, and other suitable media. Accordingly, a network communication tracked by the communication tracking module 205 can also pertain to a network service provider's response to a network user's report of an actual or potential network problem. More particularly, therefore, a network communication can correspond to a call from the at least one network-user device to the IVR 42 and/or call from a network service provider's technical support unit or operation (not shown) at, for example, the NOC 18. By tracking one or both of these types of communications, the communication tracking module 205 can determine a corresponding number of network communications that pertain to actual and potential network problems.

The report generating module 210 is communicatively linked to the communication tracking module 205 and generates a report based upon the network communications tracked by the tracking module. The report, for example, can correspond to a call detail record (CDR). The CDR, moreover, can comprise data pertaining to a call or other network communication to the IVR or network service provider device 42 and/or a call or other network communication from the technical support unit or operation.

The CDR or other type of report generated by the report generating module 210 can be sent automatically to at least one reporting target. For example, the CDR or other type of report can be sent to an e-mail target where the information contained in the report can be extracted into a database. The CDR or other reports can be distributed to various nodes or portions within the network 100. They can be configured to be carried by reporting tools defined for the network 100, as will be readily understood by one of ordinary skill in the art. The CDR or other reports can be distributed on as-needed basis or intermittently at pre-scheduled intervals.

The system 200 also illustratively includes a threshold determining module 215. The threshold determining module 215, based upon the number of network communications that pertain to actual or potential network problems tracked by the tracking module 205, determines whether the number of network communications exceeds a predetermined threshold. A number in excess of the threshold is taken as an indication of an actual or potential network problem that may require a response from the network service provider. For example, the threshold determining module 215 can comprises a rules engine configured to determine, based upon the tracked network communications, whether an inordinately high call volume is being or has been received regarding a particular network problem or pertaining to a specific part of the network 100.

The system 200 optionally includes a location indicating module 220 to indicate a location of the network-user device. The location indicating module 220, using the indicated location of the network-user device, can correlate the location indication, with a part of the network exhibiting an actual or potential network problem. More particularly, the network-user device can be identified, for example, by call detail data that includes an ANI for the network-user device. As will be readily appreciated by one of ordinary skill in the art, the ANI is typically available in real-time or near real-time through a long-distance or other type of carrier. Accordingly, in one embodiment, a CDR or other report generated by the report generating module 210 is run against one or more internal databases to determine the network nodes and/or network elements to which the ANI maps. Thus, the location indicating module 220 can compare the CDR or other report to the ANI data to determine locations of actual or potential network problems.

Optionally, the system 200 can further include a database generating module 225 that generates entries for database 90 based upon the tracked network communications. The database 90 is linked to the controller 82 on which the system is illustratively configured to run. The database 90 provides a source of data derived from the tracked network communications, the data being usable to analyze actual and potential network problems.

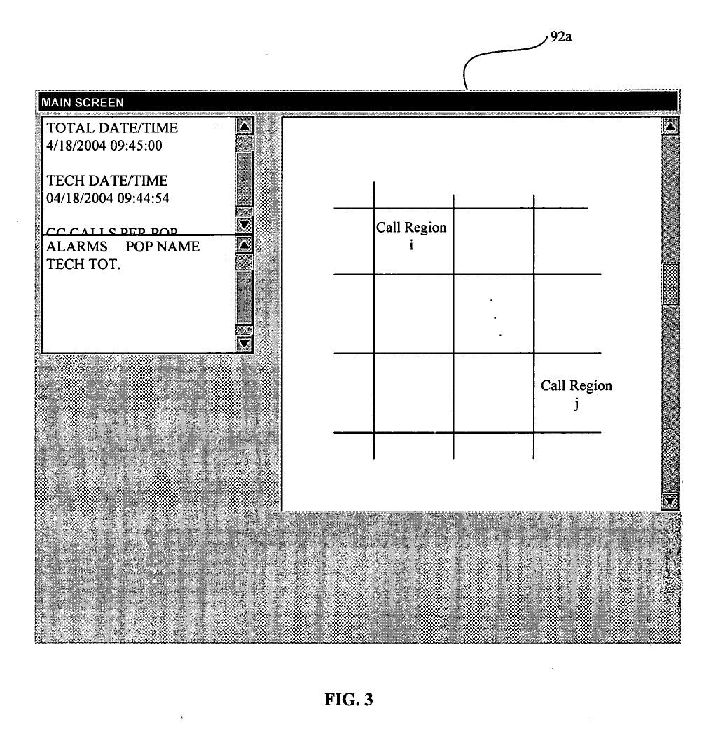

The system 200 renders one or more graphical user interfaces (GUIs) that are illustratively displayed on the monitor of a computer 88 connected to the controller 82. Alternatively, the GUIs can be displayed on any device capable of rendering a visual image and connected to the controller 82. As illustrated in FIGS. 3-5, the GUIs provide an interface that is updatable in near real-time.

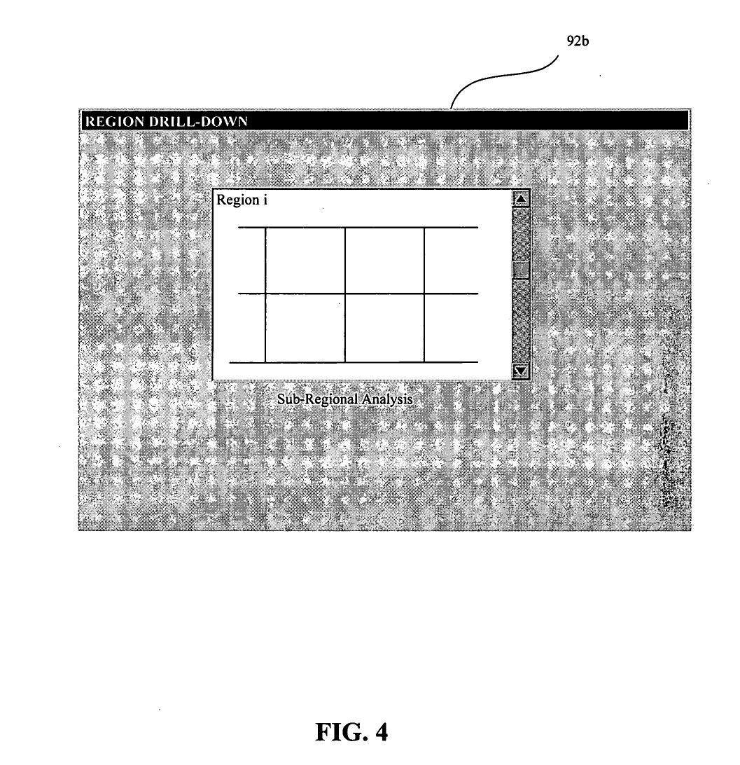

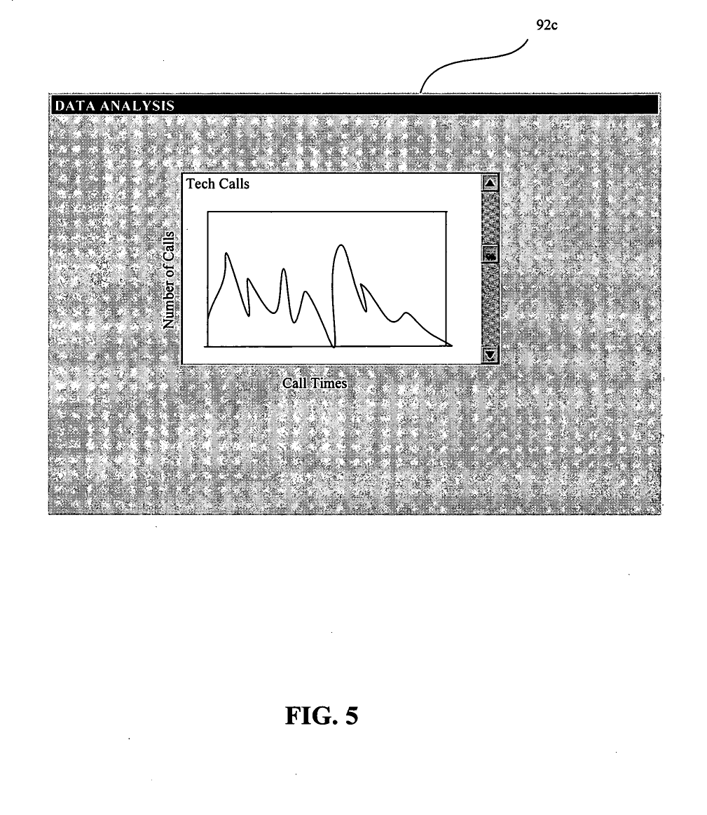

A main-screen GUI 92a shown in FIG. 3 illustratively provides an overview of actual or potential network problems, listing dates and times for network communications on a region-by-region basis. The GUIs generated by the system 200 also can include a drill-down capability as illustrated by the GUI 92b shown in FIG. 4, which provides locations within a particular region identified by the system as exhibiting actual or potential network problems. The GUIs generated by the system 200 further provide a visual presentation of the analysis performed by the system 200 as typified by the GUI 92c of FIG. 5, which displays the number of network communications in the form of calls to the NOC 18 mapped against a designated time line for the various calls.

Although the system 200 has been described in terms of software configured to run on the controller 82, it will be readily appreciated by those of ordinary skill in the art that the system 200 alternately can be implemented with hardwired circuitry comprising processing and memory storing capabilities. Such circuitry can comprise, for example, one or more logic gates and one or more memory components. Alternatively, the system 200 can be implemented as a combination of the software modules and hardwired circuitry.

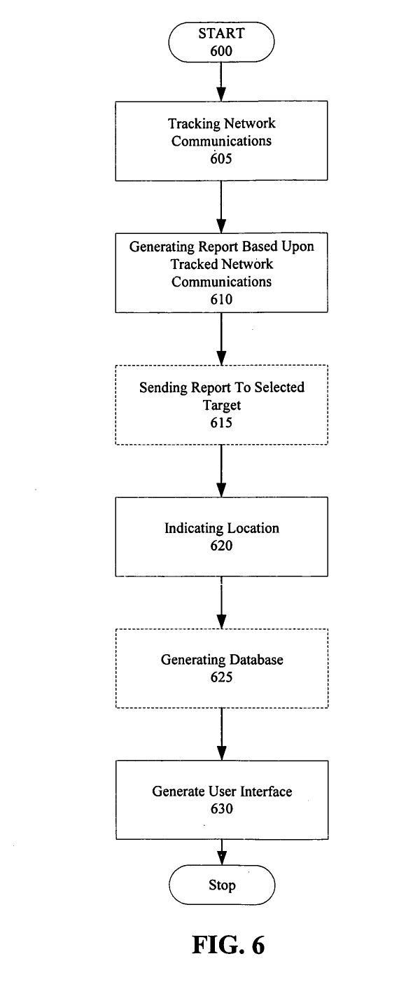

FIG. 6 provides a flowchart that illustrates certain method aspects of the present invention pertaining to monitoring a communication network for actual and potential network problems. The method 600 includes at step 605 tracking network communications between at least one network-user device and a network service provider device during a predefined time interval, the network communications being based upon a user-supplied indication of a network problem. A network communication can be a call from a network-user device to an interactive voice responder operated, controlled, or otherwise sponsored by the network service provider and/or a call from a technical support operation sponsored by the network service provider to the network-user device.

At step 610, the method 600 includes generating a report based upon the network communications tracked. The report can comprise a CDR. Optionally, the method includes sending the report to at least one pre-selected target. A report can be sent on as-needed basis or intermittently at prescheduled intervals.

The method 600 also includes determining whether the number of network communications exceeds a predetermined threshold at step 615, and, at step 620, indicating a location of an actual or potential network problem by identifying the location of a network-user device through which a network communication has been effected. A message from a network-user device can comprise an ANI, and accordingly, the step of indicating a location of an actual or potential network problem can comprise comparing the ANI to the generated report to determine locations of actual or potential network problems.

The method 600 further includes at step 625 optionally generating a database based upon the network communications tracked, and, at step 630, providing a graphical user interface. The graphical user interface can be updatable real-time or in near real-time. The graphical user interface can have drill-down capability for rendering more detailed information in response to a request and/or presenting data analysis based upon the generated report.

The method 600 described, like the already-described system 200, can be implemented in software-based modules and/or in one or more hardwired circuits. Accordingly, the present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

That claimed is:

1. A system for monitoring a communication network for actual and potential network problems, the system comprising:
a communication tracking module to track network communications between at least one network-user device and a network service provider device during a predefined time interval to thereby determine a corresponding number of network communications, the network communications being based upon an indication of a network problem;
a report generating module to generate a report based upon the network communications tracked; and
a threshold determination module to determine whether the number of network communications exceeds a predetermined threshold.

2. The system of claim 1, wherein a network communication comprises at least one of a call from the at least one network-user device to an interactive voice responder sponsored by the network service provider and a call from a technical support operation sponsored by the network service provider to the at least one network-user device.

3. The system of claim 1, further comprising a database module to automatically generate entries for a database based upon the network communications tracked.

4. The system of claim 1, wherein the reporting module sends the report to at least one pre-selected target.

5. The system of claim 1, wherein the report comprises a call detail record (CDR).

6. The system of claim 1, wherein the user-supplied indication of a network problem comprises a message from the at least one network-user device, the system further comprising:
a location indicating module to indicate a location of the at least one user device.

7. The system of claim 6, wherein the message from the at least one network-user device comprises an automatic information identification (ANI).

8. The system of claim 7, wherein the location indicating module compares the report to the ANI data to determine locations of actual and potential network problems.

9. The system of claim 1, further comprising a user interface that is updatable in near real-time and that provides at least one of drill-down capability and data analysis based upon the report.

10. A method of monitoring a communication network for actual and potential network problems, the method comprising:
tracking network communications between at least one network-user device and a network service provider device during a predefined time interval to determine a number of network communications, the network communications being based upon an indication of a network problem;
generating a report based upon the network communications tracked; and
determining whether the number of network communications exceeds a predetermined threshold.

11. The method of claim 10, wherein a network communication comprises at least one of a call from the at least one network-user device to an interactive voice responder sponsored by the network service provider and a call from a technical support operation sponsored by the network service provider to the at least one network-user device.

12. The method of claim 10, further comprising generating a database based upon the network communications tracked.

13. The method of claim 10, further comprising sending the report to at least one pre-selected target.

14. The method of claim 10, wherein the report comprises a call detail record (CDR).

15. The method of claim 10, wherein the user-supplied indication of a network problem comprises a message from the at least one network-user device, and further comprising indicating a location of the at least one user device.

16. The method of claim 15, wherein the message from the at least one network-user device comprises an automatic information identification (ANI).

17. The method of claim 16, wherein the method further comprises comparing the report to the ANI data to determine locations of actual and potential network problems.

18. The method of claim 10, further comprising providing a user interface that is updatable in near real-time and that provides at least one of drill-down capability and data analysis based upon the report.

19. A computer readable storage medium, the storage medium comprising computer instructions for:
tracking network communications between at least one network-user device and a network service provider device during a predefined time interval to determine a number of network communications, the network communications being based upon an indication of a network problem;
generating a report based upon the network communications tracked; and
determining whether the number of network communications exceeds a predetermined threshold.

20. The method of claim 19, wherein a network communication comprises at least one of a call from the at least one network-user device to an interactive voice responder sponsored by the network service provider and a call from a technical support operation sponsored by the network service provider to the at least one network-user device.
